(19) United States
(12) Patent Application Publication
(10) Pub. No.: US 2002/0009940 A1
(43) Pub. Date: Jan. 24, 2002

(54) Targeted elastic laminate having zones of different polymer materials

(76) Inventors: Raymond Jeffrey May, Norcross, GA (US); James Marcus Carr, Kaukauna, WI (US); Michael Scott Brunner, Roswell, GA (US); Lavada Campbell Boggs, Marietta, GA (US); Hannong Rhim, Roswell, GA (US); James Russell Fitts, JR., Gainesville, GA (US); Kenneth Michael Salter, LaGrange, GA (US); Victor Charles Lang, Appleton, WI (US); Adrian Roy Eggen, Appleton, WI (US); Oomman Painumoottil Thomas, Alpharetta, GA (US)

Correspondence Address: Pauley Petersen Kinne & Fejer, Suite 365, 2800 West Higgins Road, Hoffman Estates, IL, 60195, US

(21) Appl. No.: 09/855,188

(22) Filed: May 14, 2001

Related U.S. Application Data
(60) Provisional application No. 60/204,246, filed on May 15, 2000.

(51) Int. Cl. D04H 1/56; D04H 3/16; D01D 5/12; B32B 31/30

(52) U.S. Cl. 442/328; 442/329; 442/400; 442/401; 442/361; 442/415; 264/171.24; 264/210.8; 264/211.14; 264/342 RE; 156/167; 156/178; 156/179; 156/229; 156/244.11

(57) ABSTRACT

A targeted elastic laminate material having different zones of tension across a width of a material roll and methods for making the same. At least two polymers or polymer blends having different set properties are used to produce varying tension zones across the material. The targeted elastic laminate material has elastic properties that provide improved fit characteristics to disposable personal care products, while maintaining a flat roll profile that allows the material to be easily processed at a high speed.

### FIELD OF THE INVENTION

This invention relates to elastic laminate materials having different zones of elastic tension across a width of the material and processes for making the same.

### BACKGROUND OF THE INVENTION

Conventional elastic laminate materials are designed to have substantially homogeneous tension and set properties across the width of the material. These materials are often composed of either a continuous meltblown elastomer web or a series of identical continuous elastomer filaments bonded with a meltblown elastomer web. One process for producing a continuous filament stretch-bonded laminate is described in U.S. Pat. No. 5,385,775, issued to Wright, the disclosure of which is incorporated by reference. Additionally, reinforcing filaments have been produced independently of the elastomer spinning process to implement bands having greater tension. However, this procedure is expensive and results in an uncomfortable material.

Further, when conventional elastic laminate materials are wound onto rolls, the finished roll has varying diameters across the width of the roll resulting from varying tension and/or stretch across the width of the material. These varying diameters cause unwinding difficulties in the converting process due to the tendency of the material to steer across guide rolls and to not lay flat on the cutting rolls.

For these and other reasons, there is a need for a targeted elastic laminate material having different zones of tension across the width of the material, not requiring separate steps to form the high and low tension zones, for improved performance and appearance at a lower cost. Further, there is a need for an easier and less expensive process for making the targeted elastic material whereby the laminate material can be wound onto a roll having a uniform diameter across the width of the roll for easy processing.

### SUMMARY OF THE INVENTION

In accordance with this invention, the target elastic laminate (TEL) material has at least one low tension zone having a plurality of first filaments made from a first elastic polymer or polymer blend, and at least one high tension zone having a plurality of second filaments made from a second elastic polymer or polymer blend, both formed in the same extrusion step and stretched and bonded to two facing materials. The high tension zone of the material can have filaments made of a polymer or polymer blend with a higher elastic tension than the filaments in the low tension zone. A polymer blend in the high tension zone may include some of the same base polymer as a polymer blend in the low tension zone, but with a different percentage of a second component. Alternatively, polymer blends of the high and low tension zones may include different elastic base polymers.

### BRIEF DESCRIPTION OF THE DRAWINGS

FIG. 1 is a schematic view of an elastic nonwoven web including a plurality of first filaments extruded from a first die, forming at least one low tension zone, and a plurality of second filaments extruded from a second die, forming at least one high tension zone, according to one preferred embodiment of this invention;

FIG. 2 is a sectional view of a TEL material in which the high and low tension zones are accomplished using different polymers or polymer blends;

FIG. 3 is a bottom plan view of a die plate useful for making nonwoven webs having higher and lower tension zones;

FIG. 4 is a sectional view of a TEL material having high and low tension zones accomplished using different polymers provided from different die plates;

FIGS. 5A and 5B are sectional views of a TEL material in which a barrier film is inserted in at least one of the high and low tension zones;

FIG. 6 is a schematic view of one continuous vertical filament process for producing a stretch-bonded TEL material, according to one embodiment of this invention;

FIG. 7 is a schematic view of another vertical filament process for producing a stretch-bonded TEL material, according to another embodiment of this invention;

FIG. 8 is a schematic view of a horizontal continuous filament method for producing a stretch-bonded TEL material, according to one embodiment of this invention;

FIG. 9 is a perspective view of a hybrid continuous filament and vertical filament process for producing a stretch-bonded TEL material;

FIG. 10 is a schematic view of an exemplary pant-like absorbent garment with side panels made of a stretch-bonded TEL material having high tension zones and low tension zones, according to one preferred embodiment of this invention;

FIG. 11A shows one exemplary adhesive spray pattern in which the adhesive has been applied to the elastic filaments with attenuation in the cross direction;

FIG. 11B shows a second exemplary adhesive spray pattern;

FIG. 11C illustrates a third exemplary adhesive spray pattern;

FIG. 11D shows an exemplary bond angle in one exemplary adhesive spray pattern;

FIG. 12 illustrates the bonding pattern and method of calculating the number of bonds per unit length on elastic strands or filaments;

FIG. 13A shows a fourth exemplary adhesive spray pattern in a swirled-type of configuration;

FIG. 13B shows a fifth exemplary adhesive spray pattern that is more randomized and which provides a large percentage of adhesive lines in a perpendicular orientation to the elastic filaments;

FIG. 13C illustrates a sixth exemplary adhesive spray pattern having attenuation of adhesive lines in the cross-machine direction;

FIG. 13D shows a seventh exemplary adhesive spray pattern that resembles a “chain-link fence”; and

FIG. 14 is a schematic view of another vertical filament process for producing a stretch-bonded TEL material, according to another embodiment of this invention.

### DEFINITIONS

The term “targeted elastic laminate” or “TEL” refers to an elastic laminate having at least one elastic nonwoven filament web, in which different zones of different elastic tension exist across a width of the web when the laminate is stretched in a longitudinal direction perpendicular to the width. The different zones may, but do not necessarily, have different elongations at break, or recoveries. What is important is that the different zones exhibit different levels of reftractive force when the laminate is uniformly stretched by a selected amount. The elastic nonwoven filament web is laminated to at least one other layer, whereby the laminate exhibits different levels of elastic tension in zones corresponding to the high and low tension zones in the nonwoven filament web.

The term “targeted elastic stretch-bonded laminate” or “TE SBL” refers to a TEL which is formed by stretching the elastic nonwoven filament web having the zones of different elastic tension, maintaining the stretched condition of the elastic nonwoven filament web when the other layer is bonded to it, and relaxing the TEL after bonding.

The term “vertical filament stretch-bonded laminate” or “VF SBL” refers to a stretch-bonded laminate made using a continuous vertical filament process, as described herein.

The term “continuous filament stretch-bonded laminate” or “CF SBL” refers to a stretch-bonded laminate made using a continuous horizontal filament process, as described herein.

The term “elastic tension” refers to the amount of force per unit width required to stretch an elastic material (or a selected zone thereof) to a given percent elongation.

The term “low tension zone” or “lower tension zone” refers to a zone or region in a stretch-bonded laminate material having one or more filaments with low elastic tension characteristics relative to the filament(s) of a high tension zone, when a stretching or biasing force is applied to the stretch-bonded laminate material. Thus, when a biasing force is applied to the material, the low tension zone will stretch more easily than the high tension zone. At 50% elongation of the fabric, the high tension zone may exhibit elastic tension at least 10% greater, suitably at least 50% greater, desirably about 100-800% greater, or alternatively about 150-300% greater than the low tension zone.

The term “high tension zone” or “higher tension zone” refers to a zone or region in a stretch-bonded laminate material having one or more filaments with high elastic tension characteristics relative to the filament(s) of a low tension zone, when a stretching or biasing force is applied to the stretch-bonded laminate material. Thus, when a biasing force is applied to the material, the high tension zone will stretch less easily than the low tension zone. Thus, high tension zones have a higher tension than low tension zones. The terms “high tension zone” and “low tension zone” are relative, and the material may have multiple zones of different tensions.

The term “nonwoven fabric or web” means a web having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunbonding processes, air laying processes, and bonded carded web processes. The term also includes films that have been cut into narrow strips perforated or otherwise treated to allow air to pass through. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

The term “microfibers” means small diameter fibers having an average diameter not greater than about 75 microns, for example, having an average diameter of from about 1 micron to about 50 microns, or more particularly, having an average diameter of from about 1 micron to about 30 microns.

The term “spunbonded fibers” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,502,538 to Petersen, and U.S. Pat. No. 3,542,615 to Dobo et al. Spunbond fibers are quenched and generally not tacky on the surface when they enter the draw unit, or when they are deposited onto a collecting surface. Spunbond fibers are generally continuous and may have average diameters larger than 7 microns, often between about 10 and 30 microns.

The term “meltblown fibers” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than 10 microns in diameter, and are generally self bonding when deposited onto a collecting surface. Meltblown fibers used in the invention are suitably substantially continuous.

The term “polymer” generally includes but is not limited to, homopolymers, copolymers, including block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

The term “substantially continuous filaments or fibers” refers to filaments or fibers prepared by extrusion from a spinnerette, including without limitation spunbonded and meltblown fibers, which are not cut from their original length prior to being formed into a nonwoven web or fabric. Substantially continuous filaments or fibers may have lengths ranging from greater than about 15 cm to more than one meter; and up to the length of the nonwoven web or fabric being formed. The definition of “substantially continuous filaments or fibers” includes those which are not cut prior to being formed into a nonwoven web or fabric, but which are later cut when the nonwoven web or fabric is cut.

The term “fiber” or “fibrous” is meant to refer to a particulate material wherein the length to diameter ratio of such particulate material is greater than about 10. Conversely, a “nonfiber” or “nonfibrous” material is meant to refer to a particulate material wherein the length to diameter ratio of such particulate material is about 10 or less.

The term “thermoplastic” is meant to describe a material that softens when exposed to heat and which substantially returns to its original condition when cooled to room temperature.

The terms “elastic” and “elastomeric” are used interchangeably to mean a material that is generally capable of recovering its shape after deformation when the deforming force is removed. Specifically, as used herein, elastic or elastomeric is meant to be that property of any material which upon application of a biasing force, permits that material to be stretchable to a stretched biased length which is at least about 50 percent greater than its relaxed unbiased length, and that will cause the material to recover at least 40 percent of its elongation upon release of the stretching elongating force. A hypothetical example which would satisfy this definition of an elastomeric material would be a one (1) inch sample of a material which is elongatable to at least 1.50 inches and which, upon being elongated to 1.50 inches and released, will recover to a length of not more than 1.30 inches. Many elastic materials may be stretched by much more than 50 percent of their relaxed length, and many of these will recover to substantially their original relaxed length upon release of the stretching, elongating force. This latter class of materials is generally beneficial for purposes of the present invention.

The term “recover” or “retract” relates to a contraction of a stretched material upon termination of a biasing force following stretching of the material by application of the biasing force.

The term “personal care absorbent garment” includes disposable diapers, training pants, swim wear, absorbent underpants, adult incontinence products, and feminine hygiene products. For the purposes of the invention, a baby wipe is considered a personal care garment.

The term “protective garment” includes protective (i.e., medical and/or industrial) disposable gowns, caps, gloves, drapes, face masks, and the like.

The term “disposable garment” includes personal care absorbent garments and protective garments.

The term “series” refers to a set including one or more elements.

The term “set” refers to the difference between an elastic material before and after a biasing force is applied. It is measured as a percentage of the original unstretched material length. For example, if a 1.0 inch sample of elastic material were stretched to 1.50 inches, and recovered to 1.20 inches after the biasing force was removed, it would have a “set” of 20%.

### DETAILED DESCRIPTION OF THE PRESENTLY PREFERRED EMBODIMENTS

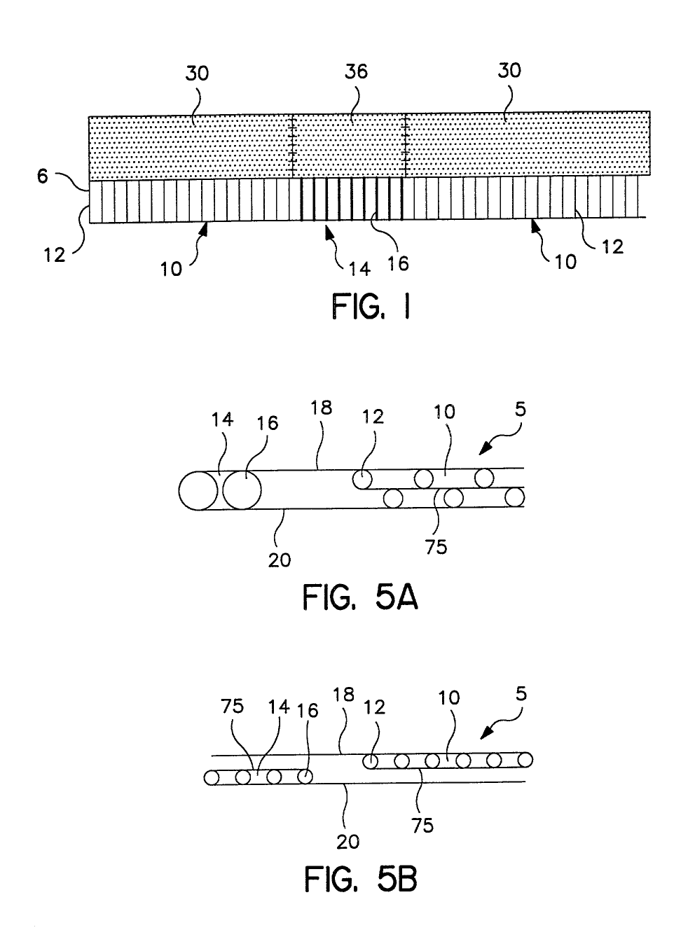

In accordance with the invention, a targeted elastic laminate material (TEL) is provided, having different zones of tension across its width. As shown in FIG. 1, the TEL includes at least one elastic nonwoven layer 6, including at least one low tension zone 10 having a plurality of elastomeric first filaments 12 and a high tension zone 14 having a plurality of elastomeric second filaments 16. First filaments 12 and second filaments 16 are made from different polymers or polymer blends, (i.e., have different compositions). The TEL material may have multiple high and low tension zones, and each zone may have a different average elastic tension and a different ultimate elongation. Again, the tension of a material is the amount of force per unit width needed to stretch the material to a given elongation. The ultimate elongation is the ultimate length per unit length that a material can be stretched to without causing permanent deformation.

First filaments 12 and second filaments 16 may have the same or different basis weights, the same or different average filament diameters, and the same or different filament densities (defined as the number of filaments per unit cross-sectional area). The basis weight of first and second filaments 12, 16 is expressed in grams per square meter (gsm) or ounces of material per square yard (osy). First and second filaments 12 and 16 can have a first basis weight of about 2 gsm to about 32 gsm, suitably about 4 gsm to about 30 gsm. An important feature of the invention is that the polymer or polymer blend used to make the second filaments 16 can have a different tension (i.e., can exhibit a different retractive force when stretched) than the polymer or polymer blend used to make the first filaments 12. Thus, TEL 5 can include a low tension zone 10 having a first tension and a high tension zone 14 having a second tension greater than the first tension. A standard tensile test can be performed on low tension zone 10 and high tension zone 14 wherein load applied to the material is measured as a function of elongation. At 50% elongation, high tension zone 14 suitably has a second tension at least 10% greater, or alternatively 50% greater, suitably about 100-800% greater, or as another alternative about 125-500% greater, or alternatively about 200-400% greater than a first tension of low tension zone 10.

Elastic tension can be measured, for instance, using an MTS Sintec Model 1/s, available from MTS in Research Triangle Park, North Carolina, with a crosshead speed set to 500 mm/min. Samples having a 3-inch width and 6-inch length can be used, with 3 inches of the length clamped inside the jaws (leaving 3 inches of length for testing). The tension of each high and low tension region can be measured after the portion of the TEL material being tested is held in the extended condition (in the machine direction of the TEL) for 60 seconds.

In one desired embodiment, at least one low tension zone 10 is laterally adjacent to at least one high tension zone 14. As shown in FIG. 1, the plurality of first filaments 12 are extruded from first die sections 30 to form low tension zone 10. The plurality of second filaments 16 are extruded from a second die section 36 to form high tension zone 14 laterally adjacent low tension zone 10. In other embodiments, low tension zone 10 and high tension zone 14 are spaced apart from each other. In another embodiment, some or all of high tension zone 14 overlaps a portion of low tension zone 10.

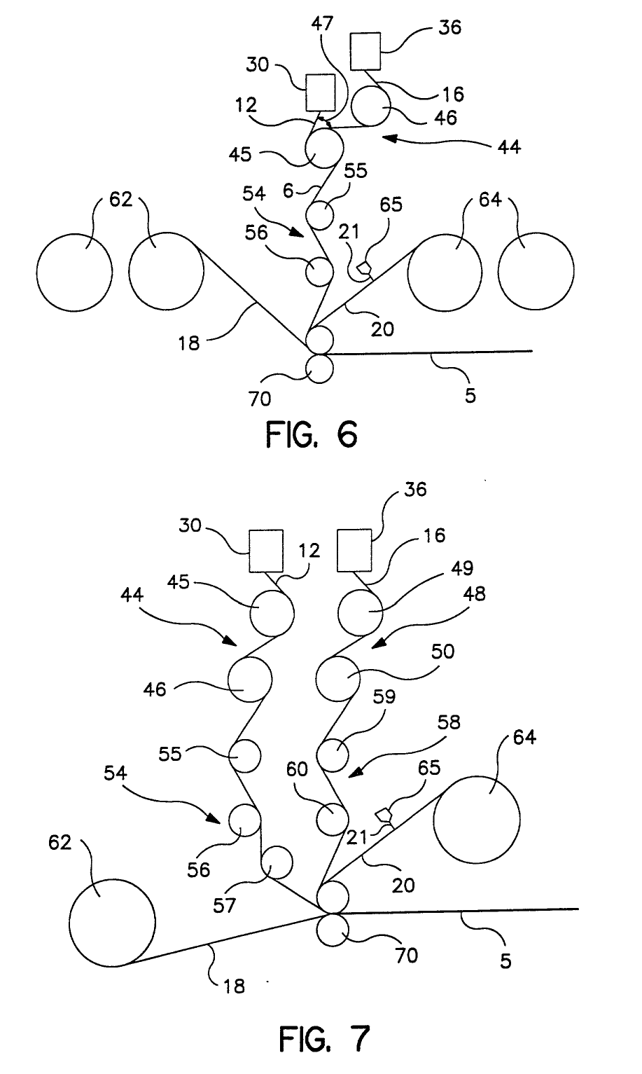

FIGS. 5A and 5B show two embodiments of a TEL material in accordance with the invention. Several examples of processes that can be used to make the TEL material are illustrated in FIGS. 6-9 and 14. As shown in FIGS. 5A and 5B, a first facing material 18 is bonded to a first side of first filaments 12 and second filaments 16. TEL 5 may also include an opposing second facing material 20 bonded to a second side of first filaments 12 and second filaments 16. Each of first facing material 18 and second facing material 20 may comprise a nonwoven web, for example a spunbonded web or a meltblown web, a woven web, a film or a meltblown continuous filament composite web. First facing material 18 and second facing material 20 may be formed using conventional processes, including the spunbond and meltblowing processes described in the above “DEFINITIONS.” For example, the facing materials may include a spunbonded web having a basis weight of about 0.1-4.0 osy, suitably 0.2-2.0 osy, desirably about 0.4-0.6 osy. First facing material 18 and second facing material 20 may comprise the same or similar material or different material.

First facing material 18 and second facing material 20 can be bonded to first filaments 12 and second filaments 16 by an adhesive, for example an elastomeric adhesive such as Findley H2525A, H2525 or H2096. Other bonding means well known to those having ordinary skill in the art may also be used to bond first facing material 18 and second facing material 20 to filaments 12 and 16 including thermal bonding, ultrasonic bonding, mechanical stitching and the like.

In one embodiment of this invention, a barrier film 75, suitably a polymer film such as a polyethylene film, is positioned between layers of first filaments 12 and/or second filaments 16 (FIG. 4A), and/or between a layer of first filaments 12 and/or second filaments 16 and first facing material 18 and/or second facing material 20 (FIG. 5B).

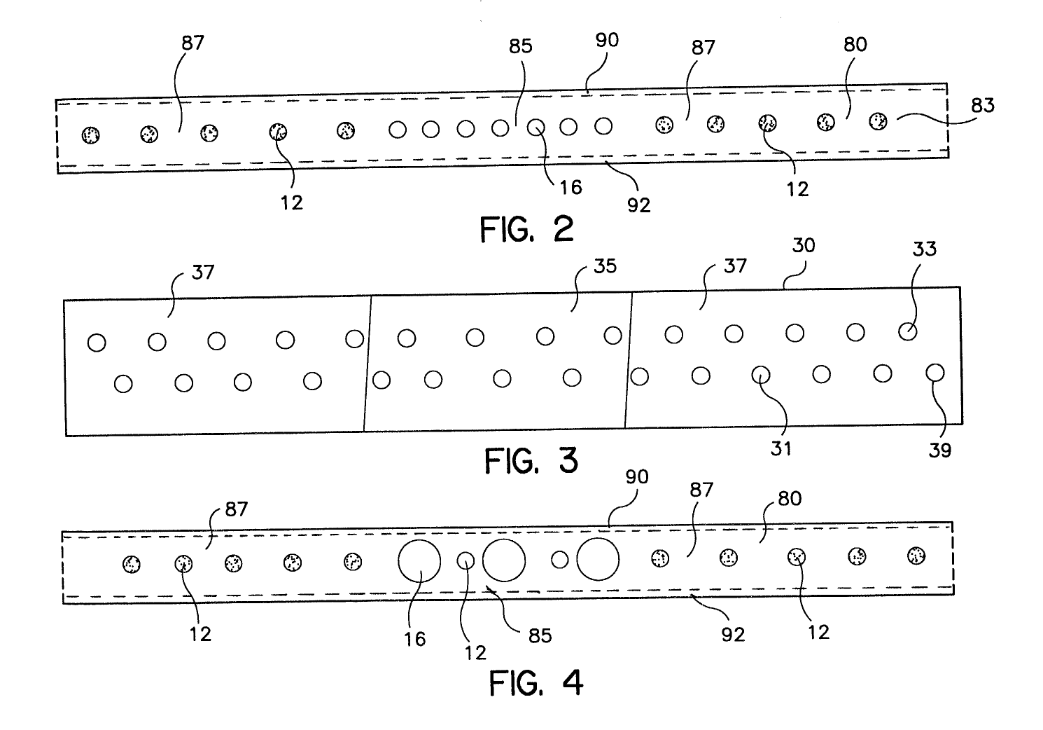

FIGS. 2-4 illustrate some TEL laminates and a die arrangement useful for preparing the elastomeric nonwoven web 6. In the laminate of FIG. 2, the nonwoven web 80 includes a plurality of lower tension elastic filaments 12 and higher tension elastic filaments 16, arranged in a single row 83. In a higher tension region 85 of the web 80, the higher tension elastic filaments (formed of an elastic polymer or polymer blend exhibiting higher elastic tension) are arranged next to each other and are substantially uniformly spaced. In two lower tension regions 87 of the web 80, pluralities of lower tension elastic filaments 12 (formed of an elastic polymer or polymer blend exhibiting lower elastic tension) are arranged next to each other, and are substantially uniformly spaced. The filaments 12 and 16 may be extruded from different zones of a single die or die arrangement, or from two or more different dies. The nonwoven web 80 is laminated between facing layers 90 and 92, which can be any of the facing materials described above.

FIG. 3 illustrates an embodiment of a single die or die assembly 30 which can be used to make a nonwoven web 80 similar to that shown in FIG. 2. In FIG. 3, the die openings 31 are arranged in two rows 33 and 39 instead of one, and are staggered so that individual openings 31 in row 33 are not directly over openings 31 in row 39. When the resulting nonwoven web is contacted with rollers or a conveyor, the extruded filaments may tend to align in a parallel fashion. The die openings 31 in central region 35 extrude the second filaments 16 from the second polymer or polymer blend. The die openings 31 in the end regions 35 and 37 extrude the first filaments 12 from the first polymer or polymer blend.

In the laminate of FIG. 4, the nonwoven web 80 is produced using a two-die system, as described below, wherein a narrower band of higher tension elastic filaments 16 is extruded over a wider band or web of lower elastic tension filaments 12. As a result, the higher tension zone 85 in the nonwoven web includes both high tension filaments 16 and low tension filaments 12. The lower tension zones 87 includes only the lower tension filaments 12.

The different polymers or polymer blends used to prepare first filaments 12 and second filaments 16 have different elastomeric properties. Materials suitable for use in preparing elastomeric first filaments 12 and second filaments 16 herein include diblock, triblock, tetrablock, or other multi-block elastomeric copolymers such as olefinic copolymers, including styrene-isoprene-styrene, styrene-butadienestyrene, styrene-ethylene/butylene-styrene, styrene-ethylene/propylene-styreneethylene/propylene tetrablock, or styrene-ethylene/propylene-styrene, which may be obtained from the Shell Chemical Company, under the trade designation KRATON® elastomeric resin; polyurethanes, including those available from B. F. Goodrich Co., under the trade name ESTANE® thermoplastic polyurethanes; polyamides, including polyether block amides available from Ato Chemical Company, under the trade name PEBAX® polyether block amide; polyesters, such as those available from E. I. Du Pont de Nemours Co., under the trade name HYTREL® polyester; and single-site or metallocene-catalyzed polyolefins having density less than about 0.89 grams/cc, available from Dow Chemical Co. under the trade name AFFINITY®.

A number of block copolymers can be used to prepare thermoplastic elastomeric filaments 12, 16 useful in this invention. Such block copolymers generally comprise an elastomeric midblock portion B and a thermoplastic endblock portion A. The block copolymers may also be thermoplastic in the sense that they can be melted, formed, and resolidified several times with little or no change in physical properties (assuming a minimum of oxidative degradation).

Endblock portion A may comprise a poly(vinylarene), such as polystyrene. Midblock portion B may comprise a substantially amorphous polyolefin such as polyisoprene, ethylene/propylene polymers, ethylene/butylene polymers, polybutadiene, and the like, or mixtures thereof.

Suitable block copolymers useful in this invention include at least two substantially polystyrene endblock portions and at least one substantially ethylene/butylene mid-block portion. A commercially available example of such a linear block copolymer is available from the Shell Chemical Company under the trade designation KRATON® G1657 elastomeric resin. Another suitable elastomer is KRATON® G2760, also available from Shell Chemical Company.

Other suitable elastomeric polymers may also be used to make thermoplastic elastomeric filaments 12, 16. These include, without limitation, elastomeric (single-site or metallocene catalyzed) polypropylene, polyethylene and other alpha-olefin homopolymers and copolymers, having density less than about 0.89 grams/cc; ethylene vinyl acetate copolymers; and substantially amorphous copolymers and terpolymers of ethylene-propylene, butene-propylene, and ethylene1 propylene-butene.

Single-site catalyzed elastomeric polymers (for example, constrained geometry or metallocene-catalyzed elastomeric polymers) are available from Exxon Chemical Company of Baytown, Tex., and from Dow Chemical Company of Midland, Mich. The single-site process for making polyolefins uses a single-site catalyst which is activated (i.e., ionized) by a co-catalyst.

Commercial production of single-site catalyzed polymers is somewhat limited but growing. Such polymers are available from Exxon Chemical Company under the trade name EXXPOL® for polypropylene based polymers and EXACT® for polyethylene based polymers. Dow Chemical Company has polymers commercially available under the name ENGAGE®. These materials are believed to be produced using non-stereo selective single-site catalysts. Exxon generally refers to their singlesite catalyst technology as metallocene catalysts, while Dow refers to theirs as “constrained geometry” catalysts under the name INSITE® to distinguish them from traditional Ziegler-Natta catalysts which have multiple reaction sites. Other manufacturers such as Fina Oil, BASF, Amoco, Hoechst and Mobil are active in this area and it is believed that the availability of polymers produced according to this technology will grow substantially in the next decade.

First filaments 12 and second filaments 16 may also contain blends of elastic and inelastic polymers, or of two or more elastic polymers, provided that the blend exhibits elastic properties. First filaments 12 and second filaments 16 may be substantially continuous or of specific length, but are desirably substantially continuous. Substantially continuous filaments have better elastic recovery than shorter filaments. First and second filaments 12, 16 may be circular but may also have other cross-sectional geometries such as elliptical, rectangular, triangular or multi-lobal. First and second filaments 12, 16 may have the same or different geometries, and the same or different sizes (e.g., diameters), and the same or different densities (expressed in number of filaments per unit cross-sectional area across the web). In one embodiment, one or more of the filaments may be in the form of elongated, rectangular film strips produced from a film extrusion die having a plurality of slotted openings.

In one desired embodiment, first filaments 12 comprise a first elastomer or elastomer blend, and second filaments 16 comprise a different elastomer or elastomer blend, having different tensile properties than the first elastomer or elastomer blend. In another desired embodiment, first filaments 12 comprise a first elastomer and second filaments 16 comprise an elastomer blend having a different percentage amount of the first elastomer, with an added non-elastic component, making the modulus of the second elastomer blend greater than the modulus of the first elastomer. This added non-elastic component also increases the set properties of the second elastomer blend relative to the first elastomer blend. For example, the second filaments may comprise KRATON® G1730 as a base elastomer, and a polyethylene wax as a processing aid. The first filaments may include the same base elastomer without the polyethylene wax, or with a lower amount of it. The combination of higher modulus and higher set properties of the second filaments provides a TEL 5 that has higher tension second filaments that can be wound up into a roll with a flat profile.

In another desired embodiment, second filaments 16 may comprise a blend of elastomers, for example KRATON® styrene-ethylene/propylene rubber and a polyethylene elastomer, having a modulus and/or basis weight (and, thus, tension) greater than a modulus and/or basis weight of a first elastomer used to form first filaments 12. The polyethylene elastomer additive increases the modulus and achieves the desired set properties for the second filaments 16 while also acting as a processing aid. This combination of first and second filaments produces a TEL material that can be wound up in a roll with a flat profile.

In one embodiment of this invention, TEL 5 is produced by a vertical continuous filament stretch-bonded laminate method (VF SBL), as shown in FIGS. 6, 7 and 14. Referring to FIG. 6, a first extruder (not shown) supplies a first molten elastomeric polymer or polymer blend to a first die 30. A second extruder (not shown) supplies a second molten elastomeric polymer or polymer blend to a second die 36. First die 30 extrudes the lower tension (desirably continuous) elastomeric filaments 12. Second die 36 extrudes the higher tension (desirably continuous) elastomeric filaments 16. The bands of filaments 12 and 16 may be joined together side-by-side to form a nonwoven layer 80 as shown in FIG. 2, having homogeneous high and low tension regions 85 and 87. Alternatively, a narrower band of higher elastomeric filaments 16 may be extruded over a wider band of filaments 12 to form a nonwoven layer 80 having a heterogenous higher tension region 85 and homogeneous lower tension regions 87 as shown in FIG. 4.

After extruding first and second filaments 12, 16, first and second filaments 12, 16 are quenched and solidified. In one desired embodiment, first and second filaments 12, 16 are quenched and solidified by passing first and second filaments 12, 16 over a first series of chill rolls 44. First series of chill rolls 44 may comprise one or more individual chill rolls 45, suitably at least two chill rolls 45 and 46, as shown in FIG. 6. Any number of chill rolls can be used. Chill rolls 45, 46 can have a temperature of about 40° F. to about 60° F. The lower tension elastic filaments 12 are cooled using chill roll 45. The higher tension filaments 16 are cooled using chill rolls 46 and 45, and converge with the lower tension filaments 12 at chill roll 45.

The die of each extruder may be positioned with respect to the first roller so that the continuous filaments meet this first roller at a predetermined angle 47. This strand extrusion geometry is particularly advantageous for depositing a melt extrudate onto a rotating roll or drum. An angled, or canted, orientation provides an opportunity for the filaments to emerge from the die at a right angle to the roll tangent point resulting in improved spinning, more efficient energy transfer, and generally longer die life. This improved configuration allows the filaments to emerge at an angle from the die and follow a relatively straight path to contact the tangent point on the roll surface. The angle 47 between the die exit of the extruder and the vertical axis (or the horizontal axis of the first roller, depending on which angle is measured) may be as little as a few degrees or as much as 90°. For example, a 90° extrudate exit to roller angle could be achieved by positioning the extruder directly above the downstream edge of the first roller and having a side exit die tip on the extruder. Moreover, angles such as about 20°, about 35°, or about 45° away from vertical may be utilized. It has been found that, when utilizing a 12-filament/inch spinplate hole density, an approximately 45° angle (shown in FIG. 6) allows the system to operate effectively. The optimum angle, however, will vary as a function of extrudate exit velocity, roller speed, vertical distance from the die to the roller, and horizontal distance from the die centerline to the top dead center of the roller. Optimal performance can be achieved by employing various geometries to result in improved spinning efficiency and reduced filament breakage. In many cases, this results in potentially increased roll wrap resulting in more efficient energy transfer and longer die life due to reduced drag and shear of the extrudate as it leaves the capillaries of the extruder die and proceeds to the chilled roll.

After first and second filaments 12, 16 are quenched and solidified, first and second filaments 12, 16 are stretched or elongated. In one desired embodiment, first and second filaments 12, 16 are stretched using a first series of stretch rolls 54. First series of stretch rolls 54 may comprise one or more individual stretch rolls 55, suitably at least two stretch rolls 55 and 56, as shown in FIG. 6. Stretch rolls 55 and 56 rotate at a speed greater than a speed at which chill rolls 45 and 46 rotate to stretch first and second filaments 12, 16.

In one desired embodiment of this invention, each successive roll rotates at a speed greater than the speed of the previous roll. For example, referring to FIG. 6, chill roll 45 rotates at a speed “x”; chill roll 46 rotates at a speed greater than “x”, for example about “1.1x”; stretch roll 55 rotates at a still greater speed, for example about “1.15x”; stretch roll 56 rotates at a still greater speed, for example of about “1.25x” to about “2x”; and a third stretch roll 57 (if present, as in FIG. 7) rotates at a still greater speed, for example about “2x” to about “7x.” As a result, first and second filaments 12, 16 can be stretched by about 100% to about 800% of an initial pre-stretched length, suitably by about 200% to about 700% of an initial pre-stretched length.

After first and second filaments 12, 16 are stretched, elastic nonwoven layer 6 is laminated to a first facing material 18 and (alternatively) a second facing material 20. First facing material 18 is laminated to a first side of nonwoven layer 6. As shown in FIG. 6, before second facing material 20 is laminated to a second side of nonwoven layer 6, at least a portion of second facing material 20 can be coated or sprayed with an elastomeric adhesive 21, such as Findley H2525A, H2525 or H2096, via an adhesive sprayer 65. The laminate material is then passed through nip rolls 70. The laminate is then relaxed and/or retracted to produce a TEL 5. Other means for bonding the laminate material known to those having ordinary skill in the art may be used in place of nip roll 70.

FIG. 7 illustrates a VF SBL process in which the second filaments 16 are extruded, cooled and stretched independently from the first filaments 12. First filaments 12 are processed in a manner similar to that described with respect to FIG. 6. First filaments 12 are extruded from spinnerette 30, quenched using chill rolls 45 and 46, and stretched using stretch rolls 55, 56 and 57. Second filaments 16 are processed in parallel fashion, (i.e., are extruded from second spinnerette 36, quenched using chill rolls 49 and 50, and stretched using stretch rolls 59 and 60). The first filaments 12 and second filaments 16 converge at the nip rolls 70 to form a nonwoven layer 6 as described above, which is simultaneously laminated between a first facing layer 18 and a second facing layer 20. The resulting laminate is then relaxed and/or retracted to form TEL 5. Except for the separate extrusion, cooling and stretching of first and second filaments 12 and 16, the VF SBL process of FIG. 7 is similar to that of FIG. 6. An advantage of the process of FIG. 7 is the possibility of having filaments 12 and 16 stretched by different amounts before lamination to the facing layers.

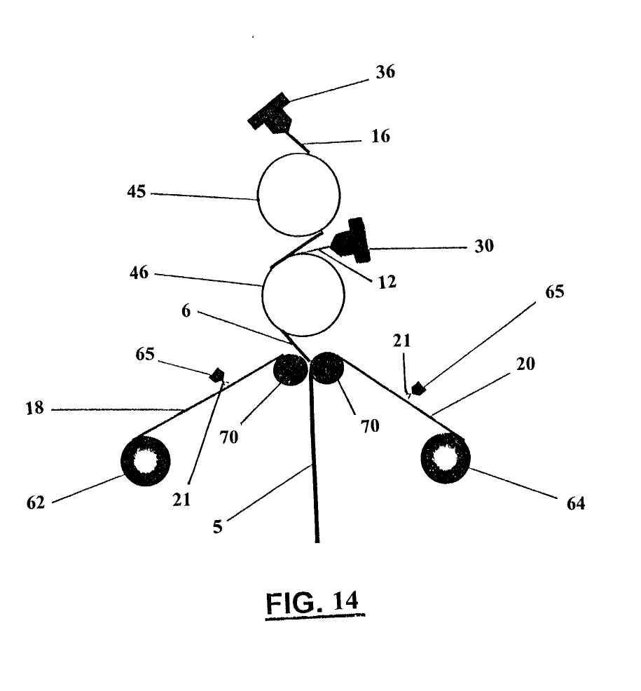

FIG. 14 illustrates a VF SBL process in which no stretch rolls 54 are used. Instead, first filaments 12 are extruded onto chill roll 46. Second filaments 16 are extruded onto chill roll 45, where the first filaments 12 and second filaments 16 converge to form a single elastic nonwoven layer 6 having zones of higher and lower elastic tensions. The first and second filaments 12, 16 are stretched between the chill rolls 45, 46 and the nip rolls 70. Except for the lack of stretch rolls 54, the processes of FIGS. 6 and 17 are similar. In either case, the elastic nonwoven layer 6 is laminated between a first facing layer 18 and a second facing layer 20 at the nip rolls 70. The resulting laminate is then relaxed and/or retracted to form TEL 5.

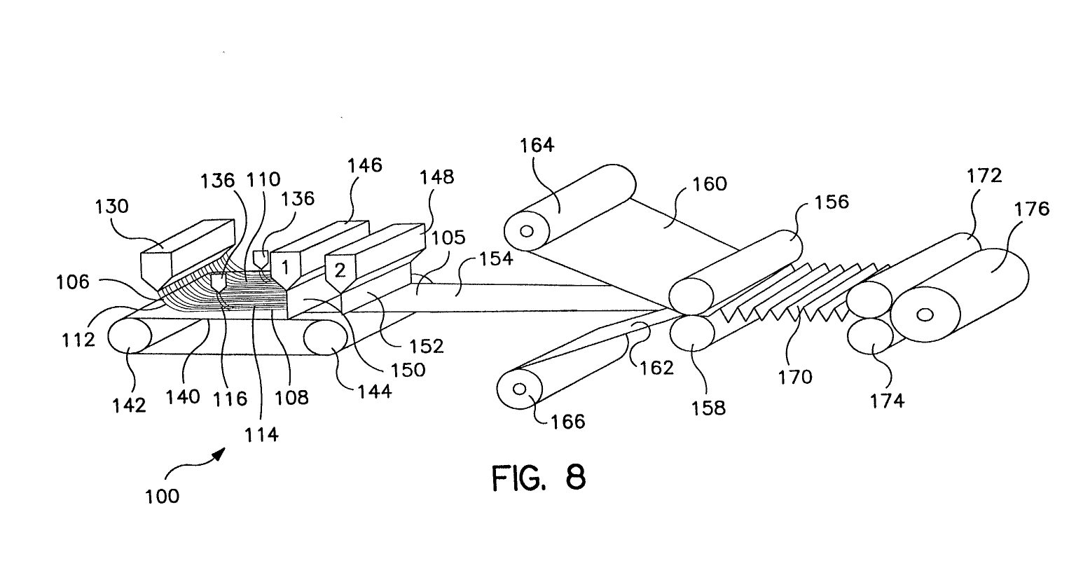

FIG. 8 illustrates a horizontal continuous filament stretch-bond laminate (CF SBL) process 100 for making the TEL of the invention. A first extrusion apparatus 130 (which can be a spinnerette, as described above) is fed with an elastomeric polymer or polymer blend using one or more extruders (not shown). In various embodiments, the extrusion apparatus 130 can be configured according to the nonwoven web and die hole arrangements illustrated in FIGS. 2-4 and described above, or similar arrangements, to form a nonwoven layer 106 having zones of higher and lower elastic tension formed by different elastic polymers or polymer blends. The different polymers or polymer blends have compositions which are selected to give the desired different elastic tensions. In another embodiment, the extrusion apparatus 130 can be configured with die holes extruding only a single polymer or polymer blend, to yield a nonwoven layer 106 which has uniform elastic tension across its width.

The nonwoven layer 106 contains filaments 112 which are substantially continuous in length. In this regard, the extrusion apparatus 130 may be a spinnerette. Suitably, apparatus 130 is a meltblowing spinnerette operating without the heated gas (e.g., air) stream which flows past the die tip in a conventional meltblowing process. Apparatus 130 extrudes filaments 112 directly onto a conveyor system, which can be a forming wire system 140 (i.e., a foraminous belt) moving clockwise about rollers 142. Filaments 112 may be cooled using vacuum suction applied through the forming wire system, and/or cooling fans (not shown). The vacuum can also help hold the nonwoven layer 106 against the foraminous wire system.

In a desired embodiment, at least one, possibly two or more second extrusion apparatus 136 are positioned downstream of the first extrusion apparatus 130. The second extrusion apparatus creates one or more higher tension zones in the nonwoven layer 106 by extruding filaments 116 of a second, higher tension elastic polymer or polymer blend, directly onto the nonwoven layer 106 in bands or zones which are narrower than the width of nonwoven layer 106. The second filaments 116 may be of the same or different size and basis weight as the first filaments 112. The extrusion of second filaments 116 over the first filaments 112 only in selected regions of layer 106, operates to create higher elastic tension zones 114, where the first and second filaments 112 and 116 coexist, and lower elastic tension zones 110 where the first filaments 112 exist alone. The first and second filaments 112 and 116 converge, and are combined in the forming conveyor 140 as it travels forward, to yield nonwoven layer 108 having at least one first zone 110 of lower elastic tension, and at least one second zone 114 of higher elastic tension and different polymer construction, similar to the web shown in FIG. 4.

As explained above, nonwoven layer 108 can be produced either a) directly from spinnerette 130, which is configured to yield zones of different polymer construction and higher and lower elastic tension, similar to FIGS. 2-4, or b) through the combined effect of spinnerette 130 to yield a uniform or nonuniform precursor web 106, and secondary spinnerettes 136 which add filaments of different polymer construction and higher elastic tension in localized regions of layer 108 by extruding secondary filaments 116 onto layer 106. In either case, the nonwoven layer 108 (including filaments 112 and 116) may be incidentally stretched and, to an extent, maintained in alignment by moving the foraminous conveyor 140 in a clockwise machine direction, at a velocity which is slightly greater than the exit velocity of the filaments leaving the die.

To make the TEL 105, the elastic nonwoven layer 108 having higher and lower elastic tension zones is reinforced with one or more elastomeric meltblown layers made of the same or different elastic polymer material. Referring to FIG. 8, meltblowing extruders 146 and 148 are used to form meltblown layers 150 and 152 onto one side of web 108, resulting in TEL 105. The meltblown layer or layers may act as structural facing layers in the laminate, and/or may act as tie layers if it is desired to add still more layers to the laminate.

Several patents describe various spray apparatuses and methods that may be utilized in supplying the meltblown layers (adhesives) to the outer facing(s) or, when desired, to the elastic strands themselves. For example, the following United States patents assigned to Illinois Tool Works, Inc. (“ITW”) are directed to various means of spraying or meltblowing fiberized hot melt adhesive onto a substrate: U.S. Pat. Nos. 5,882,573; 5,902,540; 5,904,298. These patents are incorporated herein in their entireties by reference thereto. The types of adhesive spray equipment disclosed in the aforementioned patents are generally efficient in applying the adhesive onto the nonwoven outer facings in the VFL process of this invention. In particular, ITW-brand Dynatec spray equipment, which is capable of applying about 3 gsm of adhesive at a run rate of about 1100 fpm, may be used in the melt-spray adhesive applications contemplated by the present inventive process.

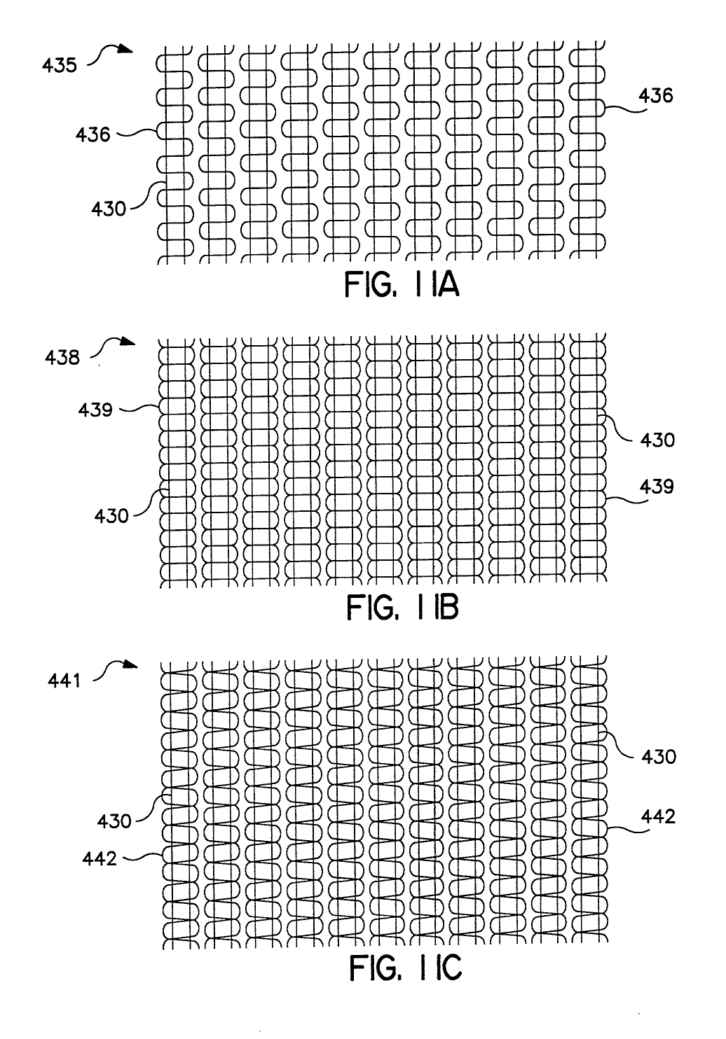

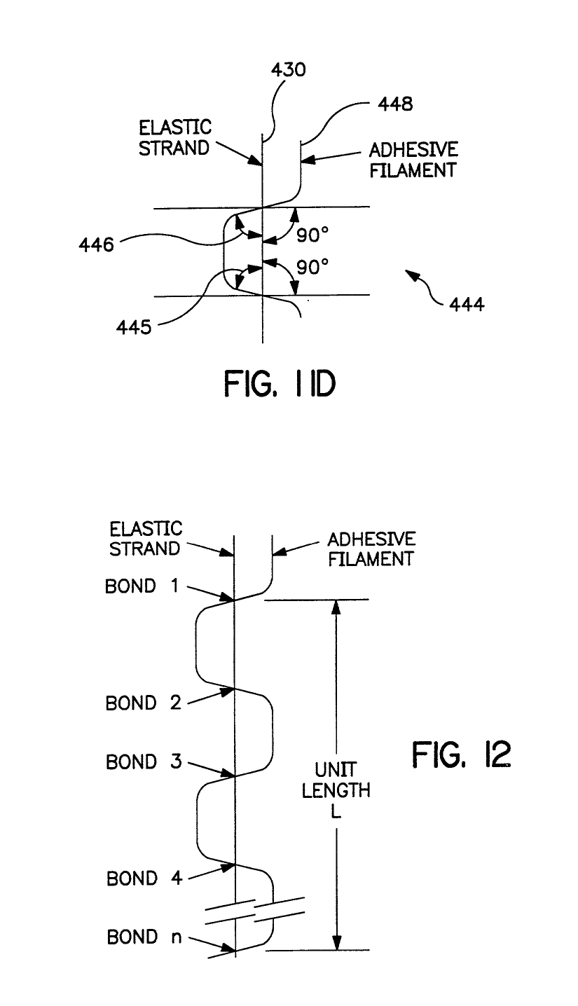

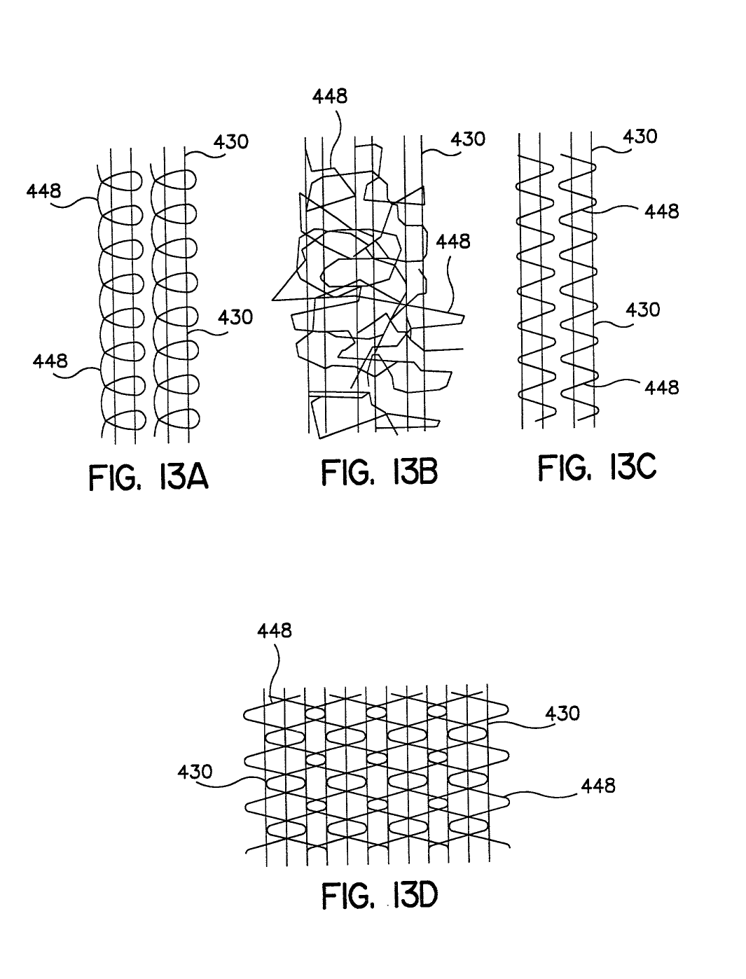

Representative adhesive patterns are illustrated in FIGS. 11A through 13D. Applying an adhesive in a cross-machine pattern such as the ones shown in FIGS. 13C and 13D may result in certain adherence advantages. For example, because the elastic strands are placed in the machine direction, having the adhesive pattern orient to a large degree in the cross-machine direction provides multiple adhesives to elastic crossings per unit length.

In addition, in many particular embodiments of the present invention, the adhesive component is applied to the surface of the nonwoven layer in discreet adhesive lines. The adhesive may be applied in various patterns so that the adhesive lines intersect the elastic filament lines to form various types of bonding networks which could include either adhesive-to-elastic bonds or adhesive-to-elastic bonds, adhesive-to-facing layer, and adhesive-to-adhesive bonds. These bonding networks may include a relatively large total number of adhesive-to-elastic and adhesive-to-adhesive bonds that provide the laminated article with increased strength, while utilizing minimal amounts of adhesive. Such enhancements are achieved by the use of adhesive sprayed onto the surface of the nonwoven in a predetermined and specific pattern. In most cases, a final product with less adhesive exhibits a reduction in undesirable stiffness, and is generally more flexible and soft than products having more adhesive.

Applying the adhesive in a pattern so that the adhesive lines are perpendicular or nearly perpendicular to the elastic components has been found particularly advantageous. A true 90° bond angle may not be possible in practice, but an average or mean bond angle that is as great as 50° or 60° will generally produce a suitable bond between the elastic strands and the facing material. A conceptual illustration of these types of bond angles is shown in FIGS. 11D and 12. The adhesive-to-elastic bonds are formed where the lines of adhesive 448 and elastic strands 430 join or intersect.

The continuous adhesive filaments-to-elastic strand intersections are also controlled to a predetermined number of intersections per unit of elastic strand length. By having such adhesive lines in a perpendicular orientation and optimizing the number of bonds per unit of elastic strand length, the final elastic strand laminate can be produced with a minimal amount of adhesive and elastomeric strand material to provide desirable product characteristics at a lower cost.

If the adhesive-to-elastic bonds are too few in number or are too weak, then the elastic tension properties of the laminate may be compromised and the tension applied to the elastic strands may break the adhesive joints. In various known processes, the common remedy for this condition is to increase the number of bonding sites by either increasing the meltspray air pressure, or by slowing the lamination speed. As the meltspray air pressure is increased, the resulting adhesive fiber size is reduced, creating weaker bonds. Increasing the amount of adhesive used per unit area to create larger adhesive filaments can strengthen these weaker bonds, which usually increases the cost of the laminate. Lowering the lamination speed decreases machine productivity, negatively impacting product cost. The present invention, in part, utilizes an effective bonding pattern where the number of bond sites per length elastic strand are prescribed and where the adhesive-to-elastic strand joints are generally perpendicular in orientation in order to provide maximum adhesive strength. This allows the laminate to be made at minimal cost by optimizing the adhesive and elastomer content to match the product needs.

As used herein, a “scrim” refers generally to a fabric or nonwoven web of material which may be elastic or inelastic, and having a machine direction (“MD”) oriented strand component along the path of product flow during manufacture and a cross-machine direction (“CD”) strand component across the width of the fabric.

FIG. 11A shows one exemplary scrim pattern useful in the present invention in which the adhesive has been applied to the elastic filaments with attenuation of the adhesive lines in the cross-machine direction. Scrim pattern 435 includes adhesive line 436 and elastic filaments 430. FIG. 11B illustrates another exemplary scrim pattern 438 having adhesive lines 439 applied to elastic strands 430. In this embodiment, it can be seen that the bond angle is very high, approaching 90° at the intersection between the adhesive and the elastic filaments. FIG. 11C illustrates still another scrim pattern 441 having adhesive lines 442 and continuous elastic strands 430.

As previously discussed, FIG. 11D illustrates the relatively high bond angle that may be employed in products produced according to the present invention. In particular, lay down angle 444 is shown as the angle formed by the adhesive line 448 and the elastic strand 430. Adhesive/elastic angle 446 and adhesive/elastic angle 445 are shown as being less than 90°.

FIG. 12 utilizes an exemplary bonding pattern to conceptually illustrate the measurement for determining the number of bonds per unit length on elastic strands or filaments. FIG. 13A shows another exemplary bonding pattern having the adhesive-to-adhesive bonding wherein a swirled type of configuration is employed. FIG. 13B illustrates a more randomized pattern wherein a large percentage of adhesive lines are in a perpendicular, or almost perpendicular, orientation to the elastic filaments. FIG. 13C is another exemplary embodiment of a bonding pattern having no adhesive-to-adhesive bonds, nut numerous adhesive-to-elastic strand bonds. FIG. 13D illustrates another exemplary bonding pattern that has both adhesive-to-adhesive and adhesive-to-elastic strand bonds. The configuration shown in FIG. 13D is similar to the design of a chain-link fence.

Then, referring back to FIG. 8 for example, if it is desired to convert the TEL 105 into a stretch-bonded laminate, the TEL 105 may be stretched in a stretching stage 154 by pulling it between two nip rolls 156 and 158 which turn at a higher surface speed than the conveyor 140. At the same time, two facing layers 160 and 162 can be unwound from supply rollers 164 and 166, and laminated to the TEL 105 using the stretch roll assembly. To accomplish this dual purpose, the nip rolls 156 and 158 may be smooth or patterned calender rolls which use pressure to bond the materials 160, 105, 162 together as well as stretch the TEL 105. Alternatively, both heat and pressure may be applied to bond the materials 160, 105, 162 together. The resulting stretch-bonded laminate 170 may then be relaxed and/or retracted using nip rollers 172 and 174 that rotate at lower surface speed than calender rolls 158, and may be wound onto storage roll 176. The facing layers 160 and 162 may be any of the facing materials described above, and are suitably polyolefin-based spunbond webs.

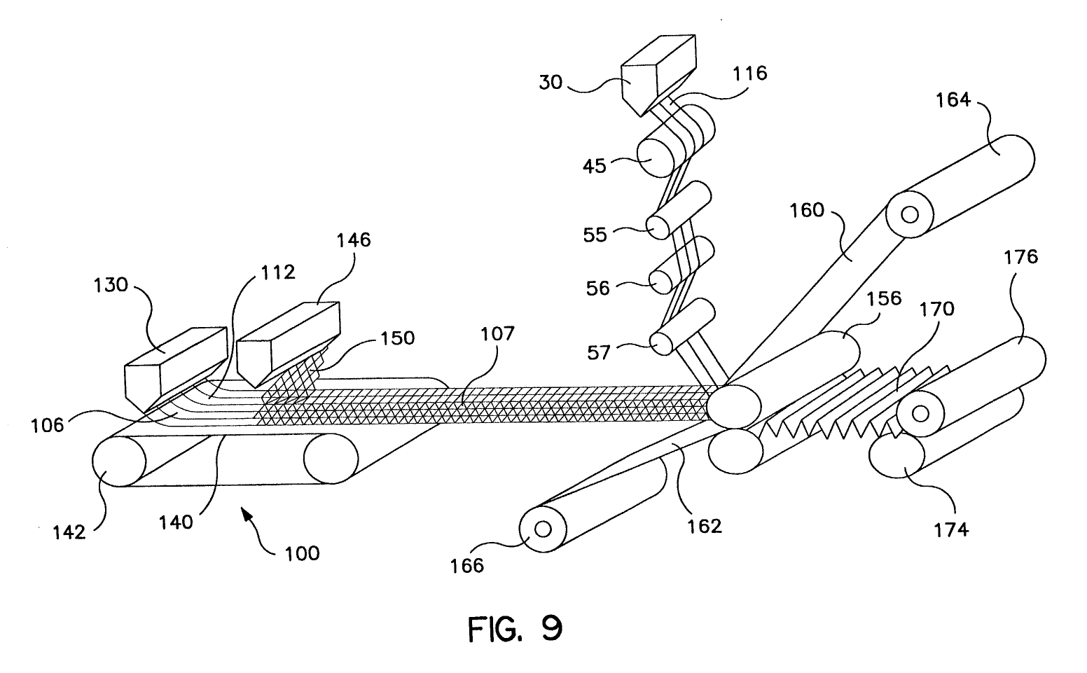

FIG. 9 illustrates a hybrid of a CF SBL process and a VF SBL process for making a stretch-bonded TEL 170. A first extrusion apparatus 130 is fed with an elastic polymer or polymer blend from one or more sources (not shown). Extrusion apparatus 130 may be any of the various devices described with respect to FIG. 8. Suitably, apparatus 130 is a meltblowing spinnerette operating without the heated gas (e.g., air) stream which flows past the die tip in conventional meltblowing processes. Apparatus 130 extrudes lower tension filaments 112 directly onto a conveyor system, which can be a forming wire system 140 (i.e., a foraminous belt) moving clockwise about rollers 142. Filaments 112 may be cooled using vacuum suction applied through the forming wire system, and/or cooling fans (not shown). The vacuum may also help hold the filaments against the forming wire system.

A meltblowing extruder 146 is used to add a reinforcing elastic meltblown layer 150 to the elastic filaments 112. Suitably, the meltblown layer 150 is made of the same elastic polymer as the low tension filaments 112. The resulting laminate 107 travels forward on the conveyor.

To make the higher tension region, a vertical filament die 30 extrudes higher tension (i.e., different polymer composition) elastic filaments 116 in a band which is narrower than the laminate 107 containing filaments 112. Filaments 116 pass around a chill roll 45, or a series of chill rolls, and a series of stretch rolls, for example three stretch rolls 55, 56 and 57, before being joined with laminate 107 between nip rolls 156 and 158, which are suitably smooth or patterned calender rolls. Simultaneously, facing layers 160 and 162 are unwound from supply rolls 164 and 166 and joined with the laminate between nip rolls 156 and 158 to make TEL 170. As TEL 170 is relaxed, it may assume the puckered configuration shown, due to retraction of high tension filaments 116 present in part of the laminate. TEL 170 may be flattened out between rolls 174 and 176, and wound onto roll 176.

TEL materials made according to the above-described embodiments of this invention can be employed in a wide variety of personal care absorbent garments including, for instance, diapers, training pants, swim wear, absorbent underpants, adult incontinence products, feminine hygiene products, baby wipes, and medical absorbent garments. TEL materials are especially useful in absorbent articles requiring elastic in the waist and/or leg regions of a wearer. TEL materials can also be used in protective garments requiring different levels of tension within an elastic region.

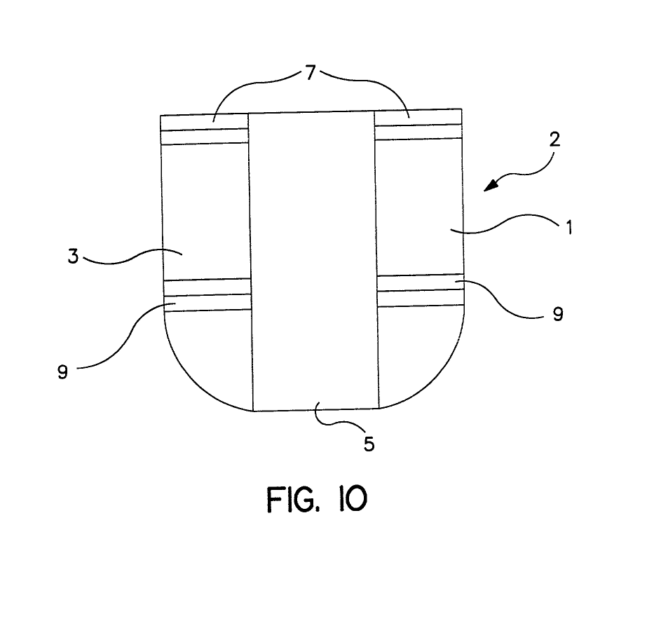

Referring to FIG. 10, a pant-like absorbent garment 2, such as training pants, includes two side panels 1 and 3 comprised of a TEL material. Waist elastic regions 7 and leg elastic regions 9 comprise high tension zones while the remaining area of side panels 1 and 3 comprises low tension zone. During use, the waist elastic regions 7 and the leg elastic regions 9 fit snugly against the wearer and effectively block most spillage of waste material which accumulates in chassis 5.

TEL 5 having a high tension zone with less retraction than a low tension zone allows the TEL to be wound onto a roll so that the roll has a uniform diameter across the width of the roll. Further, when the TEL is unwound from the roll, it lays flat on a processing surface.

### EXAMPLE 1

A roll of TE SBL was produced using the VF SBL method. The TE SBL included a web of continuous filaments of two different polymers laminated between two 0.4 osy polypropylene spunbond facing materials and bonded with Findley H2525A adhesive on one of the facing materials. The filaments of the low tension zone were produced with a lower tension elastic polymer blend available from Shell Chemical Co. of Houston, Tex., containing 85% by weight KRATON® G1730 tetrablock polymer elastomer and 15% by weight, polyethylene wax, at a calculated basis weight of approximately 8 gsm from a first die. A 1⅞-inch strip of filaments (approximately 28 gsm) forming a high tension zone were produced from a higher tension elastic polymer blend available from Shell Chemical Co., containing 70% by weight KRATON® G1730 tetrablock copolymer elastomer and 30% by weight polyethylene wax; with 1 part by weight SCC 19202 blue pigment available from Standridge Color Corp. of South Carolina; was laid down among the lower tension filaments. The higher tension filaments were stretched approximately 5.5x post chill roll and the lower tension filaments were stretched approximately 6x post chill roll. The low tension zone had a tension of about 300 grams per 3-inch sample at 50% elongation. The high tension zone had a tension of about 600 grams per 3-inch sample at 50% elongation. The variance in roll diameter of the finished roll was less than 5 mm across the material width for a 53″ diameter roll.

### EXAMPLE 2

A roll of TE SBL material was produced using the VF SBL method. The TE SBL included a web of continuous filaments including two different polymers laminated between two 0.4 osy polypropylene spunbond facing materials and bonded with Findley H2525A adhesive on one facing material. The filaments of the low tension zone were produced as in Example 1, at a calculated basis weight of approximately 8 gsm. A 1⅞-inch strip of filaments forming a high tension zone included a dry blend of 70% by weight KRATON®G1730 tetrablock polymer elastomer, 12% by weight polyethylene wax, and 18% Dow metallocene-catalyzed polyethylene (density of 0.89 grams/cc), blended 80:1 with SCC 19202 pigment at an average basis weight of 19 gsm. The high tension filaments were positioned between the low tension filaments in a 1⅞-inch strip. The low tension filaments were stretched approximately 6x post chill roll and the high tension filaments were stretched approximately 5.5x post chill roll. The low tension zone had a tension of about 400 grams per 3-inch sample at 50% elongation. The high tension zone had a tension of about 700 grams per 3-inch sample at 50% elongation. The variance in roll diameter of the finished roll was less than 5 mm across a width of the material for a 45″ diameter roll.

While the embodiments of the invention described herein are presently preferred, various modifications and improvements can be made without departing from the spirit and scope of the invention. The scope of the invention is indicated in the appended claims, and all changes that fall within the meaning and range of equivalents are intended to be embraced therein.

What is claimed:

1. A targeted elastic laminate material, comprising:
at least one low tension zone, the low tension zone including a plurality of elastomeric first filaments, the first filaments including a first elastomeric polymer;
at least one high tension zone, the high tension zone including a plurality of elastomeric second filaments, the second filaments including a second elastomeric polymer; and
a facing material bonded to at least a first side of the low tension zone and a first side of the high tension zone.

2. The targeted elastic laminate material of claim 1, wherein the first filaments and the second filaments each comprise a base polymer selected from the group consisting of styrene-isoprene-styrene block copolymers, styrenebutadiene-styrene block copolymers, styrene-ethylene/butylene-styrene block copolymers, styrene-ethylene/propylene-styrene-ethylene/propylene tetrablock copolymers, styrene-ethylene/propylene-styrene block copolymers, polyurethanes, elastomeric polyamides, elastomeric polyesters, elastomeric polyolefin homopolymers and copolymers, atactic polypropylenes, ethylene vinyl acetate copolymers, single-site or metallocene catalyzed polyolefins having a density less than about 0.89 grams/cc, and combinations thereof.

3. The targeted elastic laminate material of claim 2, wherein the first filaments and the second filaments comprise the same base polymer, in different percentage amounts.

4. The targeted elastic laminate material of claim 2, wherein the first filaments comprise a first base polymer and the second filaments comprise a second base polymer different from the first base polymer.

5. The targeted elastic laminate material of claim 3, wherein the second filaments comprise the base polymer and a processing aid.

6. The targeted elastic laminate material of claim 3, wherein the first and second filaments comprise the base polymer and a processing aid, in different percentage amounts.

7. The targeted elastic laminate material of claim 5, wherein the processing aid comprises a polyethylene wax.

8. The targeted elastic laminate material of claim 1, wherein the high tension zone has an elastic tension at least 10% greater than the low tension zone.

9. The targeted elastic laminate material of claim 1, wherein the high tension zone has an elastic tension at least 50% greater than the low tension zone.

10. The targeted elastic laminate material of claim 1, wherein the high tension zone has an elastic tension about 100% to about 800% greater than the low tension zone.

11. The targeted elastic laminate material of claim 1, wherein the high tension zone has an elastic tension about 125% to about 500% greater than the low tension zone.

12. The targeted elastic laminate material of claim 1, wherein the high tension zone has an elastic tension about 200% to about 400% greater than the low tension zone.

13. The targeted elastic laminate material of claim 1, wherein the high tension zone is formed by placing the second filaments among some of the first filaments.

14. The targeted elastic laminate material of claim 1, wherein the high tension zone is formed by placing the second filaments in a separate, non-overlapping region from the first filaments.

15. The targeted elastic laminate material of claim 1, wherein the facing material comprises a material selected from a nonwoven web, a woven web and a film.

16. The targeted elastic laminate material of claim 1, wherein the facing material comprises a spunbond material.

17. The targeted elastic laminate material of claim 1, wherein the facing material comprises a meltblown continuous filament composite web.

18. The targeted elastic laminate material of claim 1, further comprising a second facing material bonded to a second side of the low tension zone and a second side of the high tension zone.

19. The targeted elastic laminate material of claim 1, wherein the low tension zone and the high tension zone are bonded to the facing material with an elastomeric adhesive.

20. A wound up roll of substantially uniform diameter comprising the material of claim 1.

21. A garment comprising the targeted elastic laminate material of claim 1.

22. A method of producing a targeted elastic laminate material, comprising the steps of:
extruding a plurality of elastomeric first filaments having a first elastomeric composition, from a first spinning system;
extruding a plurality of elastomeric second filaments having a second elastomeric composition, from a second spinning system;
cooling the first and second filaments;
stretching the first and second filaments;
forming a laminate material by adhering the stretched first and second filaments to a first facing material and an opposing second facing material; and
relaxing the laminate material.

23. The method of claim 22, wherein the first spinning system comprises a first die having at least one spin plate region with a plurality of spinning holes.

24. The method of claim 22, wherein the second spinning system comprises a second die having at least one spin plate region with a plurality of spinning holes.

25. The method of claim 22, wherein the cooling step is accomplished by passing the first and the second filaments over a series of chill rolls.

26. The method of claim 22, wherein the cooling step is accomplished by placing the first and second filaments on a foraminous belt and applying a vacuum through the belt.

27. The method of claim 22, wherein the stretching step is accomplished by passing the first and second filaments over a series of stretch rolls.

28. The method of claim 27, wherein the series of stretch rolls comprises a first stretch roll and a second stretch roll, the first stretch roll rotates at a first speed and the second stretch roll rotates at a second speed greater than the first speed.

29. The method of claim 22, wherein the second spinning system further comprises a third die.

30. The method of claim 22, wherein the first filaments define a lower tension zone and the second filaments define a higher tension zone.

31. The method of claim 22, wherein the first and second filaments are substantially continuous.

32. The method of claim 22, wherein the first filaments comprise a first elastomer and the second filaments comprise a second elastomer different from the first elastomer.

33. The method of claim 22, wherein the first filaments comprise a first elastomer blend and the second filaments comprise a second elastomer blend different from the first elastomer blend.

34. The method of claim 22, wherein the first filaments comprise a first elastomer and the second filaments comprise a different percentage amount of first elastomer.

35. The method of claim 22, wherein the second filaments form a high tension zone that overlaps at least a portion of a low tension zone formed by the first filaments.

36. The method of claim 22, wherein the first filaments are cooled by passing the first filaments through a first series of chill rolls and the second filaments are cooled by passing the second filaments through a second series of chill rolls.

37. The method of claim 36, wherein the first filaments are stretched by passing the first filaments through a first series of stretch rolls and the second filaments are stretched by passing the second filaments through a second series of stretch rolls.

38. The method of claim 37, wherein the amount of stretching of the first and second filaments is independently controlled.

39. The method of claim 22, wherein the first filaments are cooled by placing the first filaments on a foraminous belt and applying a vacuum through the belt, and the second filaments are cooled by passing the second filaments through a second series of chill rolls.

40. The method of claim 39, wherein the first filaments are stretched by passing the first filaments through a first series of stretch rolls and the second filaments are stretched by passing the second filaments through a second series of stretch rolls.

41. The method of claim 40, wherein the amount of stretching of the first and second filaments is independently controlled.

42. The method of claim 22, wherein the first and second filaments are stretched by about the same amount.

43. The method of claim 22, wherein the first filaments are stretched by a different amount than the second filaments.

44. The method of claim 22, wherein the first and second filaments are stretched by about 25% to about 800% of an initial length.

45. The method of claim 22, wherein the first and second filaments are stretched by about 50% to about 700% of an initial length.

46. The method of claim 22, further comprising the step of aligning the first filaments and the second filaments during the stretching step.

47. The method of claim 22, wherein a barrier layer is positioned between the first facing material and the second facing material before the laminate material is bonded.

48. The method of claim 22, wherein the second spinning system comprises a plurality of individually controllable spin plate regions.

49. The method of claim 22, wherein the second spinning system further comprises a third die having a spin plate region with a plurality of spinning holes.

50. A disposable garment comprising a targeted elastic laminate material, the targeted elastic laminate material comprising:
at least one low tension zone, the low tension zone having a plurality of first filaments made of a first elastomeric polymer composition;
at least one high tension zone, the high tension zone having a plurality of second filaments made of a second elastomeric polymer composition;
a facing material bonded to at least a first side of the low tension zone and a first side of the high tension zone.

51. The disposable garment of claim 50, wherein the first and second filaments comprise substantially continuous filaments.

52. The disposable garment of claim 50, comprising a diaper.

53. The disposable garment of claim 50, comprising training pants.

54. The disposable garment of claim 50, comprising swim wear.

55. The disposable garment of claim 50, comprising absorbent underpants.

56. The disposable garment of claim 50, comprising a baby wipe.

57. The disposable garment of claim 50, comprising an adult incontinence product.

58. The disposable garment of claim 50, comprising a feminine hygiene product.

59. The disposable garment of claim 50, comprising a protective garment.
